(19) United States
(12) Patent Application Publication
(10) Pub. No.: US 2020/0391501 A1
(43) Pub. Date: Dec. 17, 2020

(54) DOOR LOCKS

(71) Applicant: Hewlett-Packard Development Company, L.P., Spring, TX (US)

(72) Inventors: Mark Hirst, Boise, ID (US); Mark J Wibbels, Boise, ID (US)

(21) Appl. No.: 16/975,226

(22) PCT Filed: Mar. 6, 2018
(86) PCT No.: PCT/US2018/021161

§ 371 Date: Aug. 24, 2020

(51) Int. Cl. B41F 31/02; E05B 47/00; E05B 37/16

(52) U.S. Cl. CPC B41F 31/02; E05B 37/16; E05B 47/0001

(57) ABSTRACT

An example door lock includes a button with a first region and a second region. The button actuates among multiple positions upon being engaged. A first link member is aligned to the button to detect a state of engagement of a door to a consumables compartment of an electronic device. A sensor is aligned to the button and the first link member to receive a signal from a signal generator based on the state of engagement of the door. A second link member has a first end to align with the button, and a second end to engage the door. A transducer causes the first end to align with the button to disengage the second end from the door upon engagement of the button with the first end.

### BACKGROUND

Image processing devices contain consumables such as ink cartridges. The consumables are typically retained within compartments. Users access the consumables by opening/closing the compartment doors.

### BRIEF DESCRIPTION OF THE DRAWINGS

The following detailed description references the drawings, wherein:

FIG. 1 is a schematic diagram illustrating a door lock, according to an example.

FIG. 2A is a schematic diagram illustrating a side view of the button of the door lock of FIG. 1, according to an example.

FIG. 2B is a schematic diagram illustrating a front view of the button of the door lock of FIG. 1, according to an example.

FIG. 3 is a schematic diagram illustrating the button of the door lock of FIG. 1 in a first position, according to an example.

FIG. 4 is a schematic diagram illustrating the button of the door lock of FIG. 1 in a second position, according to an example.

FIG. 5A is a schematic diagram illustrating the button of the door lock of FIG. 1 in a third position and engaging the second link member, according to an example.

FIG. 5B is a schematic diagram illustrating a rear view of the second link member of the door lock cut along line A-A of FIG. 5A, according to an example.

FIG. 6A is a schematic diagram illustrating a front view of the first link member of the door lock of FIG. 1, according to an example.

FIG. 6B is a schematic diagram illustrating a rear view of the first link member of the door lock of FIG. 1, according to an example.

FIG. 7 is a schematic diagram illustrating the door lock of FIG. 1 where a signal transmission is blocked to a sensor, according to an example.

FIG. 8A is a schematic diagram illustrating a door lock with a door latch being engaged, according to an example.

FIG. 8B is a schematic diagram illustrating the door latch of FIG. 8A being engaged allowing a door to open, according to an example.

FIG. 9 is a block diagram illustrating a door lock system, according to an example.

FIG. 10 is a block diagram illustrating a door lock system with door opening and closing controls, according to an example.

FIG. 11 is a schematic diagram illustrating an electronic device implementing the door lock system of FIG. 10, according to an example.

FIG. 12 is a block diagram illustrating a system to control opening and closing a door of an electronic device, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Consumables, such as ink cartridges, can be valuable and premature removal of these consumables from image processing devices can be unnecessarily wasteful. The compartment doors of image processing devices that are used to access consumables allow for easy access to the consumables. However, this ease of access may result in unnecessary removal of a consumable prior to the actual termination of its product life. According to some examples, image processing devices may be subject to a service or product contracting plan, whereby a user and/or owner of an image processing device may pay a service charge to lease the device for a specified period of time, and whereby a service technician is made available to perform scheduled and/or as-needed maintenance of the device including replacement of parts and/or consumables of the device. The cost of these service plans often includes the material cost to replace the consumables contained in the device.

To minimize cost and maximize profit of managed print services, user access of the consumables; i.e., print and toner cartridges in the case of an image processing device, should be restricted to those times when the cartridges are actually empty. Accordingly, premature replacement of consumables prior to complete use and depletion of all materials contained therein, may unnecessarily increase the operating costs for an image processing device, and may result in wasting unused consumable materials, which increases replenishment costs and may adversely impact environmental effects as a result of disposing unused consumables. Furthermore, increasing the frequency of opening/closing compartment doors to the consumable compartments of an image processing device and removing/inserting consumables may add to the deterioration of the image processing device, and may increase the possibility of damaging the device. Conventionally, the task of unlocking a consumables access feature requires electromechanical changes to the control panel or user interface of the device, and utilize separate trigger mechanisms to perform the task. A first trigger mechanism is typically required to request access to the consumables compartment, and a second trigger mechanism is required to perform the mechanical latch release function. Further, a separate mechanism is typically required to determine whether the door is physically open or closed after access. Finally, there is typically an electromechanical lock or latch to prevent unauthorized compartment door access.

In order to address this, the examples described below provide a single button mechanism providing for the latch release of an access door to a consumables compartment of an image processing device or other type of electronic device. No electromechanical changes are required to the control panel or user interface of the device to implement the examples described herein, thereby resulting in minimized implementation costs and maximized ease of use. The latch release mechanism may be an electromechanical device that allows unlocking of a consumable compartment door only when the consumables are empty, or if approved by a service contractor. For example, the consumable compartment may contain print cartridges, which can be removed by a user. However, the compartment door should preferably not be opened if the print cartridges are not empty, thus not requiring removal. The latch release mechanism receives instructions from a processor whether to permit the door to be opened or to remain closed. The latch release mechanism contains a button having a hole. In an example, a light emitting diode is adjacent to the button and transmits a light through the hole and onto a light/optical sensor positioned on the opposite side of the button. When the light sensor senses the light, it retains a latch in position against the compartment door to retain the door in the locked position. When the button is pressed, the hole no longer aligns with the light being transmitted from the light emitting diode and the light sensor no longer senses the light. At this point, the processor engages a transducer such as a solenoid, which allows the button to be further pressed, which then releases the latch and allows the door to open. The processor initially senses whether the door is open/closed and permits/prevents the button from being further pressed based on the position of the door.

According to the examples described herein, a single button may be used to both (1) request release of a consumables door, and (2) actuate the release of the door by combining the sensing of whether the door is open or closed using a single sensor for detecting the status of the door as well as detecting whether the button has been initially pressed to request that the door be unlocked. This may help minimize device processing attrition and repair or replacement costs by combining the sensing of the button being pressed with the function of sensing whether the door is open or closed.

In the examples described herein, the terms “couple”, “coupled”, and/or “couples” are intended to include suitable indirect and/or direct connections. Thus, if a first component is described as being coupled to a second component, that coupling may, for example, be: (1) through a direct electrical or mechanical connection, (2) through an indirect electrical or mechanical connection via other devices and connections, (3) through an optical electrical connection, (4) through a wireless electrical connection, (5) a communicative connection, and/or (6) another suitable coupling. The terms “connect” or “connects” is intended to include direct mechanical and/or electrical connections. However, the words “operatively connect”, “operatively connected” or “operatively connecting” are intended to include indirect mechanical and/or electrical connections.

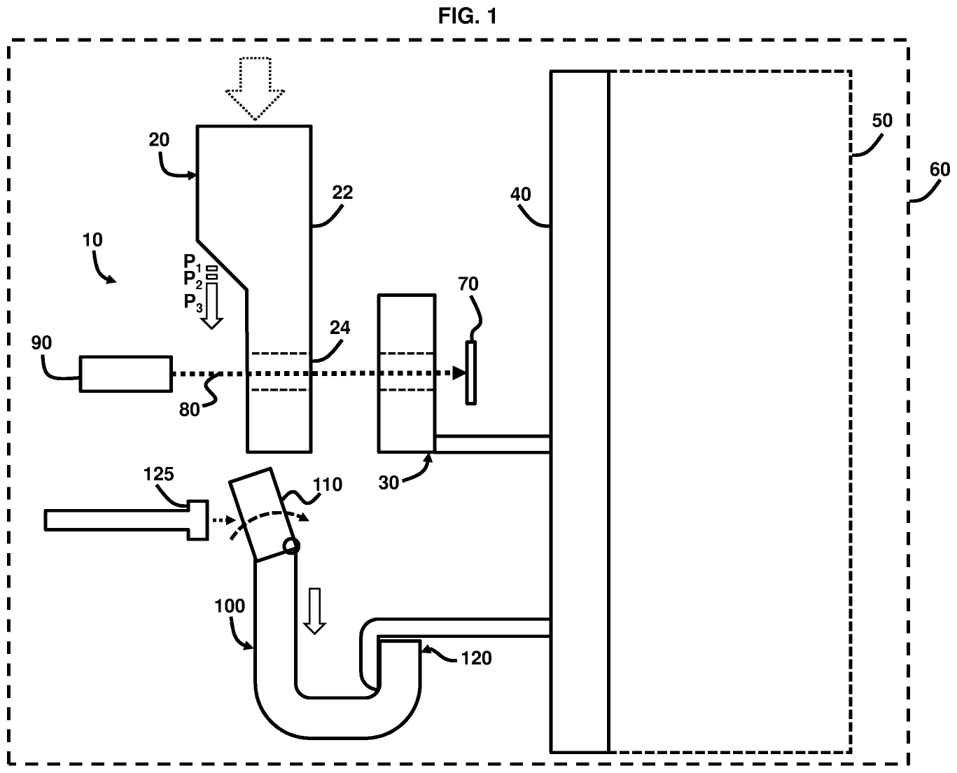

FIG. 1 is a schematic diagram illustrating a door lock 10 comprising a button 20. In an example, the button 20 may be configured as any type of structural device integrated with an electronic device 60 through any of an electrical, mechanical, and magnetic connection. The button 20 may comprise any suitable size and shape and may be formed of any suitable material appropriate for the particular electronic device 60 to which it is integrated. For example, the button 20 may be plastic, metal, or contain a polymer material. The button 20 is configured to be pressed or otherwise engaged by a user's finger, etc. or any type of engagement device such as a stylus, etc., as indicated by the dotted arrow depicted above the button 20 in the drawings. In another example, the button 20 may be programmed or communicatively controlled to be engaged or pressed without user intervention or without being pressed by an engagement device. The button 20 comprises a first region 22 and a second region 24. The first region 22 and second region 24 may be suitably sized based on the overall size and shape of the button 20, and the first region 22 and the second region 24 may be formed of the same material or may contain different materials from one another.

The button 20 is to actuate among multiple positions P₁, P₂, P₃ upon being engaged. According to some examples, the multiple positions P₁, P₂, P₃ may be linearly or non-linearly aligned. Moreover, the relative distance between the respective multiple positions P₁, P₂, P₃ may be uniform or non-uniform, according to various examples. For example, the distance between first position P₁ and second position P₂ may be equal to the distance between second position P₂ and third position P₃, or alternatively the respective distances may be unequal. In an example, the first position P₁ may be considered the initial position of the button 20 prior to the button 20 being pressed.

A first link member 30 is aligned to the button 20 to detect a state of engagement of a door 40 to a consumables compartment 50 of an electronic device 60. In an example, the first link member 30 comprises a mechanical structure that is positioned adjacent to the button 20. Depending on the orientation of the movement of the button 20, the first link member 30 may be positioned at any suitable orientation relative to the button 20. The first link member 30 is operatively connected to the door 40. In an example, the door 40 may be a push/pull type door that rotatably opens or closes with respect to the electronic device 60. However, the door 40 may also be configured in other ways such as a slide-type door, etc. The button 20 and door 40 may be positioned on any location of the electronic device 60, and the button 20 and door 40 do not necessarily have to be physically located adjacent to one another so long as there is operable connection between the two components either through direct or indirect connection.

The consumables compartment 50 may stores consumables, not shown in FIG. 1. In an example, the consumables may include such items as print deposition materials; i.e., toner, ink, powder, and media. Accordingly, the consumables may comprise any type of material used by an electronic device 60 to provide printing and/or imaging functionalities. However, the consumables may also comprise other types of materials not related to printing or imaging such as batteries, processing equipment, communication equipment, and hardware components, and may be made of valuable materials such as gold or copper, etc.

The electronic device 60 may be any type of electronic device such as an image processing device, communication device, hardware device, and computing device, etc. that contains consumables. In an example, an image processing device may be a hardware device, such as a printer, multifunction printer, or any other device with functionalities to physically produce representation(s); e.g., text, images, models, etc., on a medium. In examples, a medium may include paper, photopolymers, thermopolymers, plastics, textile, composite, metal, and wood, among others.

A sensor 70 is aligned to the button 20 and the first link member 30 to receive a signal 80 from a signal generator 90 based on the state of engagement of the door 40. The sensor 70 may be any suitable type of sensing device including, for example, an optical sensor, electro-mechanical switch, compound magnetic circuit, photodetector, image sensor, fiber optic sensor, ultrasonic, quantum sensor, time-of-flight camera, and acoustic sensor, among others. The signal generator 90 that generates the signal 80 may be any suitable type of signal generation device that generates repeating or non-repeating analog or digital signals, and accordingly the signal 80 may be any suitable type of signal. Some examples of the signal generator 90 include radio frequency and microwave signal generators, audio signal generators, video signal generators, and light emitting diodes, among others. Some examples of the signal 80 include analog signals, digital signals, audio signals, electromagnetic signals, light, and the signal 80 may be continuous, discrete, periodic, non-periodic, virtual, or non-virtual signals, among other types of signals. Depending on the path of the signal 80 from the signal generator 90 and the orientation of the movement of the button 20, the sensor 70 may be positioned at any suitable orientation relative to the button 20 and/or the first link member 30.

As used herein, the state of engagement of the door 40 refers to positioning of the door 40; i.e., open or closed. In some examples, rather than being merely a binary state; i.e., either open or closed, the state of engagement of the door 40 may also include the extent of opening/closure. For example, the state of engagement of the door 40 may refer to the percentage that the door 40 is open/closed; i.e., 10% open, 50% open, 99% open, etc. The state of engagement of the door 40 effects the positioning of the first link member 30 since the first link member 30 is operatively connected to the door 40. When the door is in a closed position, as shown in FIG. 1, the first link member 30 is also in its initial/set position and the signal 80 is transmitted from the signal generator 90, through the second region 24 of the button 20, and onto the sensor 70. The positioning of the first link member 30 in the initial/set position, as shown in FIG. 1, permits a clear transmission of the signal 80 onto the sensor 70 without interference or blocking of the signal 80. The sensor 70 is programmed to consider the door 40 to be in a closed or “ready” position whenever the sensor 70 detects the signal 80 and based on a previous position of the door 40. In this regard, the “ready” position refers to the door 40 being closed against the electronic device 60 thereby securing or preventing access to the consumables compartment 50, and for the door 40 to be ready for engagement; i.e., opening, upon permission being granted based on a state of the consumables compartment 50. In an example, the state of the consumables compartment 50 may refer to the amount of consumable material remaining in one or more components in the consumables compartment 50 or the state of operation of the one or more components in the consumables compartment 50; i.e., whether the components are properly functioning and/or require servicing, repair, or replacement.

A second link member 100 is provided and comprises a first end 110 to align with the button 20, and a second end 120 to engage the door 40. In an example, the second link member 100 comprises a mechanical structure that is positioned adjacent to the button 20. Depending on the orientation of the movement of the button 20, the second link member 100 may be positioned at any suitable orientation relative to the button 20. The second link member 100 is operatively connected to the door 40. In an example, the first end 110 of the second link member 100 may be rotatable, and the second end 120 may be substantially hook-shaped, although other shapes and configurations are possible.

A transducer 125 is provided to cause the first end 110 to align with the button 20 to disengage the second end 120 from the door 40 upon engagement of the button 20 with the first end 110. In an example, the transducer 125 may be any suitable type of electrical, mechanical, electromechanical, or magnetic device capable of converting a first signal in a first form of energy into a second signal in a second form of energy. As an example, the transducer 125 may be a solenoid that converts input voltage into linear motion. The linear motion causes the transducer 125 to engage the first end 110 of the second link member 100 causing the first end 110 to rotate and align with the button 20. When the button 20 is pressed to the third position P₃, the button 20 pushes the first end 110 of the second link member 100, which causes the second end 120 to disengage from the door 40.

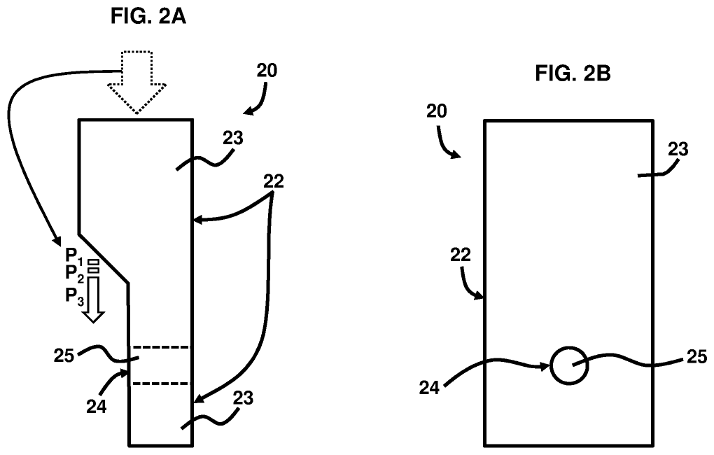

FIGS. 2A and 2B, with reference to FIG. 1, further illustrate the button 20. In an example, the first region 22 of the button 20 comprises a solid body 23, and the second region 24 of the button 20 comprises a hole 25. The second region 24 containing the hole 25 may be positioned anywhere in the button 20 so long as the hole 25 is aligned to permit transmission of the signal 80 onto the sensor 70, as indicated in FIG. 1. Furthermore, the hole 25 may take any shape or size, again so long as it permits transmission of the signal 80 through the button 20 and onto the sensor 70. In other examples, the hole 25 may be filed with filtering material, not shown, to permit transmission of the signal 80 in a controlled manner, as desired depending on the strength and type of signal 80, as well as the type of sensor 70 being used.

The multiple positions of the button 20 comprise a first position P₁, a second position P₂, and a third position P₃. In an example, the first position P₁ may be considered to occur at a distance of 0 mm from the initial resting position of the button 20; i.e., the position where the button 20 is at rest without being pressed or being pressed without causing a depression of the button 20. The second position P₂ may occur at a distance of approximately 3-5 mm of being pressed compared to the first position P₁, in an example. The third position P₃ may occur at a distance of approximately 15 mm of being pressed compared to the first position P₁, according to an example. These distances are merely examples and other distances may occur depending on the size of the button 20 and type of electronic device 60.

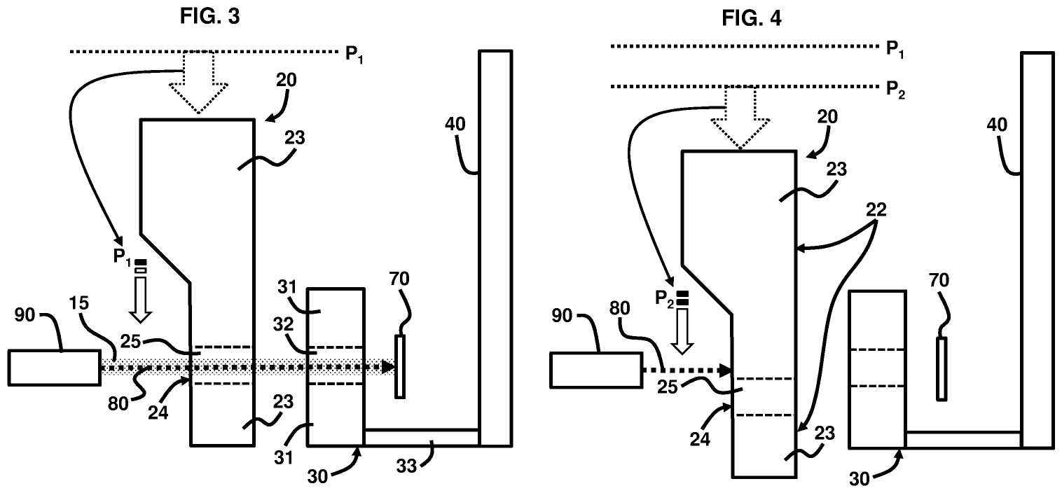

As shown in FIG. 3, with reference to FIGS. 1 through 2B, the hole 25 of the second region 24 of the button 20 may be provided to permit transmission of the signal 80 along a signal path 15 to the sensor 70 upon the button 20 being in the first position P₁. The first link member 30 comprises a solid body 31 and a hole 32 to permit the signal 80 to be transmitted to the sensor 70 when the first link member 30 is aligned with the button 20, and more particularly, when the hole 25 of the button 20 is aligned with the hole 32 of the first link member 30. Additionally, the first link member 30 comprises a shaft 33, which is configured to engage the door 40. The shaft 33 provides the structural connection between the first link member 30 and the door 40, and accordingly any movement; i.e., rotation, by the door 40 causes a corresponding movement; i.e., rotation of the first link member 30.

As shown in the example of FIG. 4, with reference to FIGS. 1 through 3, the first region 22 of the button 20 is configured to block transmission of the signal 80 to the sensor 70 upon the button 20 being actuated into the second position P₂. As a result of the button 20 being pressed to the second position P₂, there is no longer a signal path 15 from the signal generator 90 to the sensor 70 since the hole 25 is no longer aligned in the signal path 15, and thus the solid body 23 of the first region 22 of the button 20 interferes with the transmission of the signal 80 effectively blocking the signal 80 at that point, and thus, not allowing the signal 80 to reach the sensor 70. Because the signal 80 is typically constantly being transmitted to the sensor 70, any cessation of the reception of the signal 80 by the sensor 70, or change in the frequency of the reception of the signal 80 from a predetermined frequency, is identified as an instruction to the transducer 125 of FIG. 1 to engage/fire.

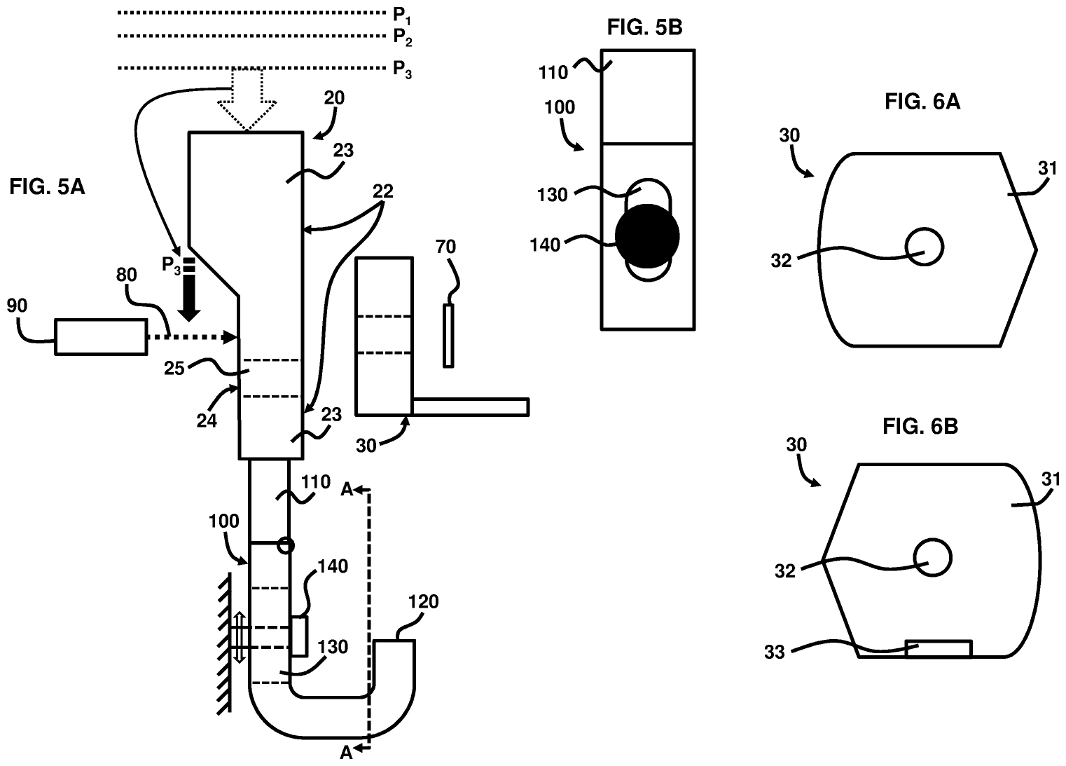

As shown in FIG. 5A, with reference to FIGS. 1 through 4, the door lock 10 may comprise a slot 130 in the second link member 100, and a pin 140 slidably positioned in the slot 130 to permit the second link member 100 to actuate upon the button 20 being actuated into the third position P₃. While the pin 140 is described herein as being slidably positioned in the slot 130, in fact, the pin 140 is fixed in position, and it is the second link member 100 that slides with respect to the pin 140 due to the elongated slot 130 that permits the second link member 100 to slide with respect to the pin 140. In this regard, the pin 140 provides a stabilizing function to retain the second link member 100 in its proper position(s) in the electronic device 60 and in proper alignment with respect to the door 40. In FIG. 5A, the first end 110 of the second link member 100 has been pushed into an aligned position with the button 20 by the transducer 125, which is not shown in FIG. 5A. When the button 20 pushes the first end 110, the second link member 100 is permitted to translate, with the pin 140 in the slot 130 providing the guide for translation of the second link member 100. Because the second link member 100 is one structural component, although the first end 110 may be rotatably connected thereto, translation of any portion of the second link member 100 causes translation of all portions of the second link member 100 including the second end 120. FIG. 5B, with reference to FIGS. 1 through 5A, illustrates a rear view of the second link member 100 cut along line A-A of FIG. 5A, according to an example. The slot 130 may be configured in any suitable size and shape so long as it is permitted to accommodate slidable movement with respect to the pin 140 positioned therethrough.

FIGS. 6A and 6B, with reference to FIGS. 1 through 5B, are schematic diagrams illustrating the first link member 30, according to an example. FIG. 6A depicts an example of a front view of the first link member 30, and FIG. 6B depicts an example of the rear view of the first link member 30. The solid body 31 of the first link member 30 may comprise any suitable size and shape. The hole 32 may also have any suitable size and shape, and may be positioned at any location in the first link member 30 so long as it is capable of being aligned along the signal path 15 of FIG. 3 to permit the signal 80 to be transmitted to the sensor 70. Similarly, the shaft 33 may have any suitable size and shape, and may be positioned at any location on the first link member 30 so long as the shaft 33 does not interfere with the signal path 15, and so long as the shaft 33 is able to operatively connect to the door 40.

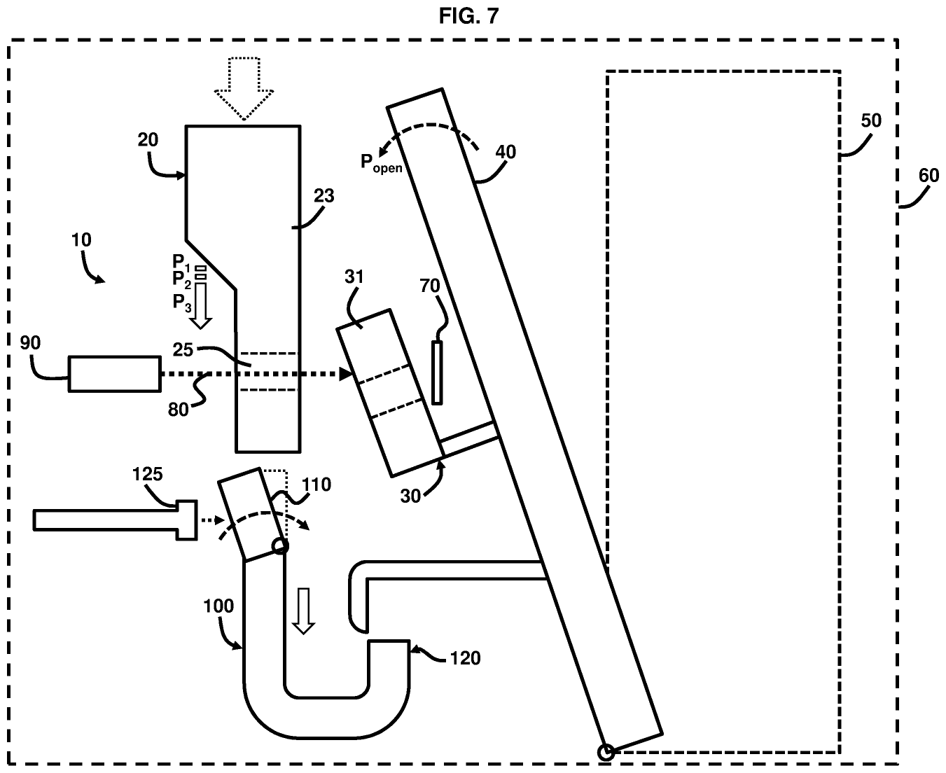

As shown in FIG. 7, with reference to FIGS. 1 through 6B, the first link member 30 is to block transmission of the signal 80 to the sensor 70 upon detecting that the door 40 is in an open position Pₒₚₑₙ. This may be considered as a “not ready” position whereby, although the hole 25 of the button is aligned to allow the signal 80 to pass through the button 20, the open position Pₒₚₑₙ of the door 40 causes the first link member 30 to rotate out of its aligned position thereby causing the solid body 31 of the first link member 30 to block the transmission of the signal 80, which prevents reception of the signal 80 by the sensor 70. While FIG. 7 depicts rotation of the door 40 and a corresponding rotation of the first link member 30, this is merely an example, and accordingly depending on the manner in which the door 40 opens; i.e., rotating, sliding, pull-push, removal, etc., the first link member 30 may be similarly actuated. However, when the door 40 is in the open position Pₒₚₑₙ, irrespective of the manner in which the door 40 opens, this causes the first link member 30 to block the transmission of the signal 80. The single sensor 70 is used to detect the initial press of the button 20; e.g., first position P₁, as well as to detect whether the door 40 is open or closed. As the stroke of the button 20 press increases; e.g., from first position P₁ to second position P₂, the transducer 125 is activated if access to the consumables compartment 50 is permitted based on a status of the consumables in the consumables compartment 50. The action of the transducer 125 allows the further stroke of the button 20; e.g., to third position P₃, to allow the second link member 100 to engage the release/opening of the door 40. If access to the consumables compartment 50 is not permitted; e.g., based on the status of the consumables in the consumables compartment 50, etc., then the transducer 125 does not activate so that any further stroke/pressing of the button 20 does not cause the first end 110 of the second link member 100 to become aligned with the button 20 thereby preventing the second end 120 of the second link member 110 from disengaging from the door 40, which retains the door 40 in a closed/locked position. FIG. 7 illustrates an example whereby the door 40 may be initially open, Pₒₚₑₙ, and the second link member 100 is not engaging/locking the door 40.

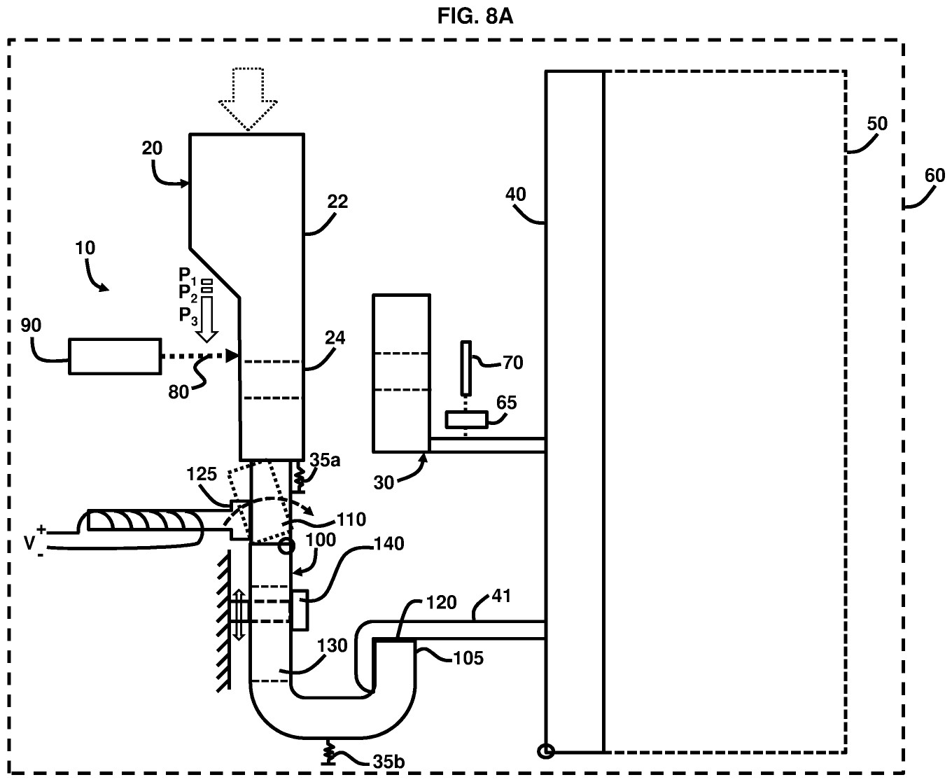

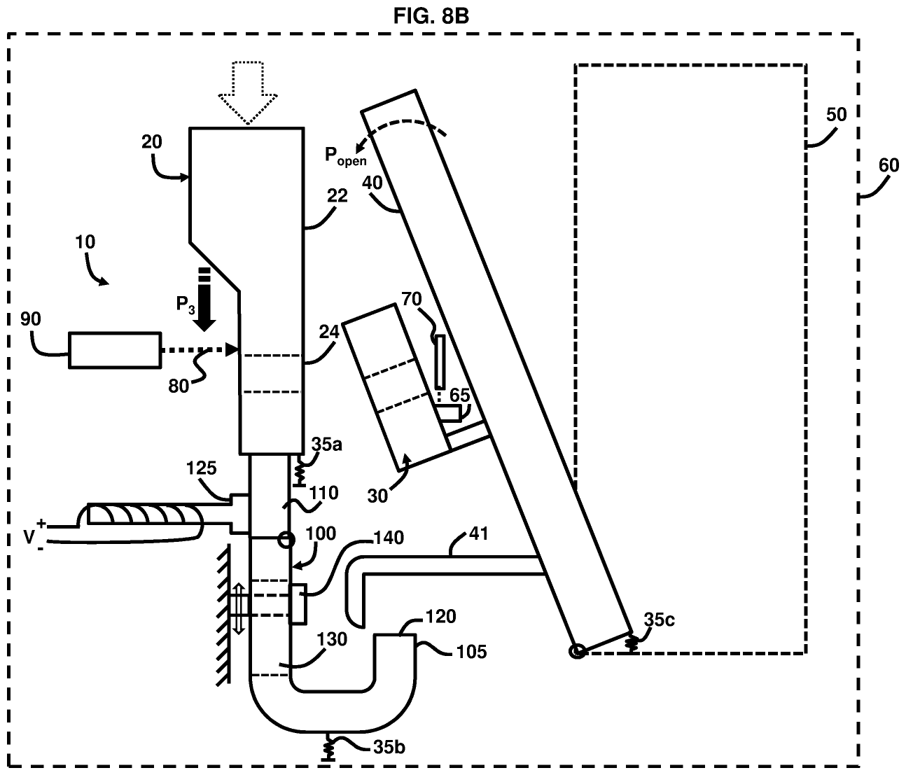

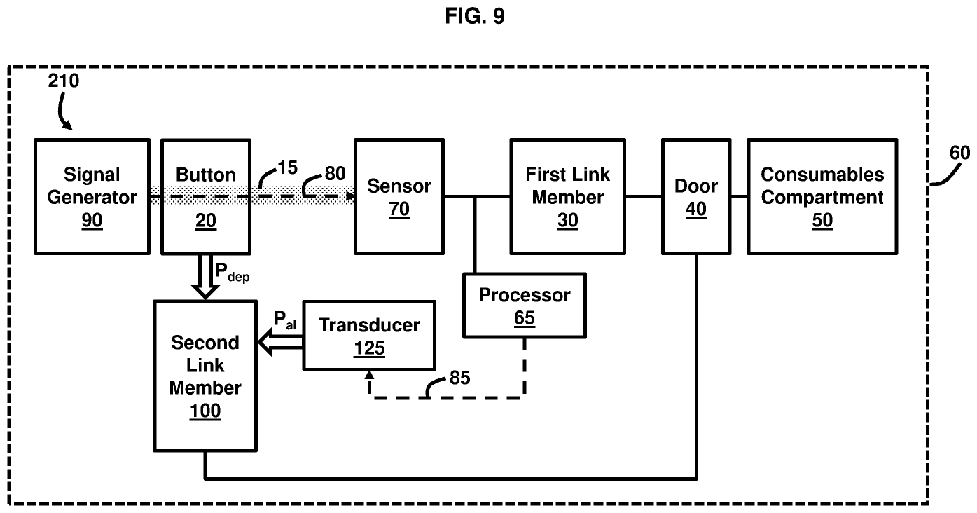

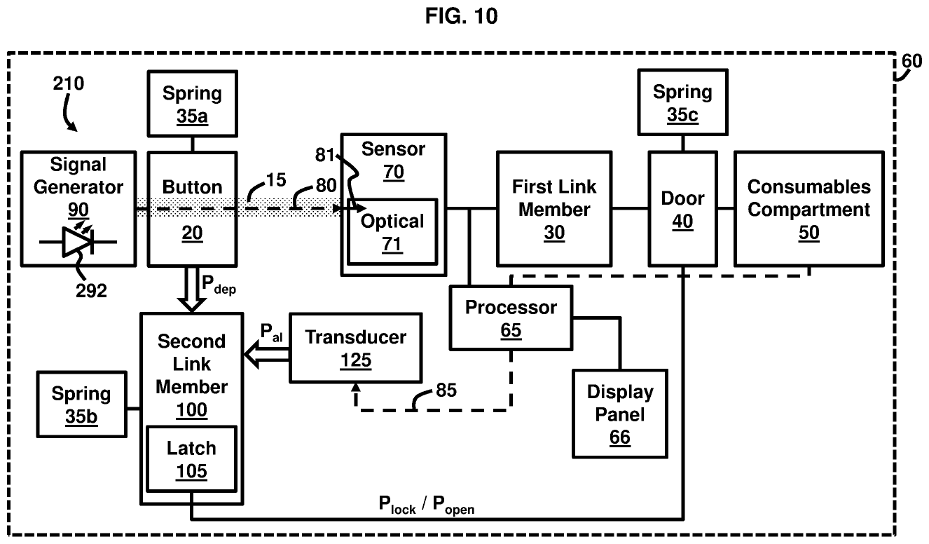

FIGS. 8A and 8B, with reference to FIGS. 1 through 7, illustrate the sequence of disengagement of the second link member 100 from the door 40 to permit unlocking of the door 40, and thus permitting the door 40 to be moved into the open position Pₒₚₑₙ. The sensor 70 is communicatively coupled to a processor 65, which provides instructions to the transducer 125 for engaging/firing. While not specifically shown in FIGS. 8A and 8B due to the orientation of the drawings, the processor 65 is communicatively coupled to the transducer 125 in order to transmit the instructions. In the examples shown in FIGS. 8A and 8B, the transducer 125 may be a solenoid. Initially in a locked position, the door 40 must be closed as indicated in FIG. 8A and the latch 105 of the second link member 100 remains interlocked with the corresponding door latch 41 of the door 40 thereby retaining the door 40 in a closed/locked position. In this regard, the button 20 is not pressed and the sensor 70 is able to receive the signal 80 uninterrupted, which is generally shown in FIG. 1. This is considered as the “ready” state of operation of the door lock 10. Pushing the button 20 to the first second position P₂ blocks the signal 80 from reaching the sensor 70, which indicates to the processor 65 that since the door lock 10 was initially in the “ready” state of operation, the button 20 must have been pressed. If the button 20 had not been pressed but the signal 80 is blocked from reaching the sensor 70, then the processor 65 determines that the door 40 is in the open position Pₒₚₑₙ, as shown in FIG. 7. Accordingly, the processor 65 is configured to be state aware to determine and assess what the blockage of the signal 80 indicates and whether the transducer 125 should be triggered/fired.

Transmission of the signal 80 to the sensor 70 is blocked by the first region 22 of the button 20 in FIG. 8A, and the button 20 has been pressed. Accordingly, if access to the consumables compartment 50 is permitted as deduced by the processor 65 based on the status of consumables in the consumables compartment 50, then pressing the button 20 interrupts the signal 80 from reaching the sensor 70, and the processor 65 transmits instructions to the transducer 125 to become energized and actuate the first end 110 of the second link member 100 to become aligned with the button 20, which allows further pressing of the button 20 to the third position P₃ to allow the second link member 100 to slide with respect to the slot 130 and pin 140, which unlocks the latch 120 of the second link member 100 from the corresponding door latch 41 of the door 40 as indicated in FIG. 8B, thereby allowing the door 40 to be opened, Pₒₚₑₙ, and permit access to the consumables compartment 50.

As indicated in FIGS. 8A and 8B, springs 35a, 35b, 35c may be provided to bias against the button 20, second link member 100, and door 40, respectively, to control movement and permit resetting of the positions of the button 20, second link member 100, and door 40 upon re-closing of the door 40. The springs 35a, 35b, 35c may be configured as any type of resilient component to bias against the button 20, second link member 100, and door 40, respectively, and reset the positions of the respective components. By re-closing the door 40, the processor 65 resets the position of the button 20, second link member 100, and transducer 125. Moreover, by re-closing the door 40 and resetting the position of the button 20, the first link member 30 automatically resets its position to be aligned with the signal path 15, and to allow the signal 80 to be transmitted uninterrupted to the sensor 70.

FIG. 9, with reference to FIGS. 1 through 8B, is a block diagram illustrating a door lock system 210, according to an example. The door lock system 210 comprises a signal generator 90 to transmit a first signal 80 in a signal path 15. A sensor 70 is to receive the first signal 80. A button 20 is to open or block the signal path 15. A first link member 30 is to detect a state of position of a door 40 to a consumables compartment 50 of an electronic device 60. A processor 65 is operatively connected to the sensor 70 and the first link member 30. The processor 65 is to detect whether the button 20 is in a depressed position P_{dep} based on whether the sensor 70 uninterruptedly receives the first signal 80, receive the state of position of the door 40 from the first link member 30, and generate a second signal 85 upon detecting that the sensor 70 fails to receive the first signal 80, and determining that the state of position of the door 40 is closed. A second link member 100 is engaged by the button 20 to unlock the door 40 upon aligning with the button 20. A transducer 125 is to move the second link member 100 in an aligned position Pₐₗ with the button 120 upon receiving the second signal 85 from the processor 65.

As shown in FIG. 10, with reference to FIGS. 1 through 9, the signal generator 90 may comprise a light emitting diode 292. The second link member 100 comprises a latch 105 to retain the door 40 in a locked position P_{lock}. The door lock system 210 comprises a plurality of springs 35a, 35b, 35c biased against the button 20, the second link member 100, and the door 40. The door lock system 210 comprises a display panel 66 operatively connected to the processor 65 to output any of a status of the state of position of the door 40, a status of a position of the button 20, and an indication of whether the door 40 is permitted to be in an open position Pₒₚₑₙ. The processor 65 is to determine whether the door 40 is to be opened once the button 20 is depressed. The first signal 80 comprises light 81, and the sensor 70 comprises an optical sensor 71 aligned with the signal path 15.

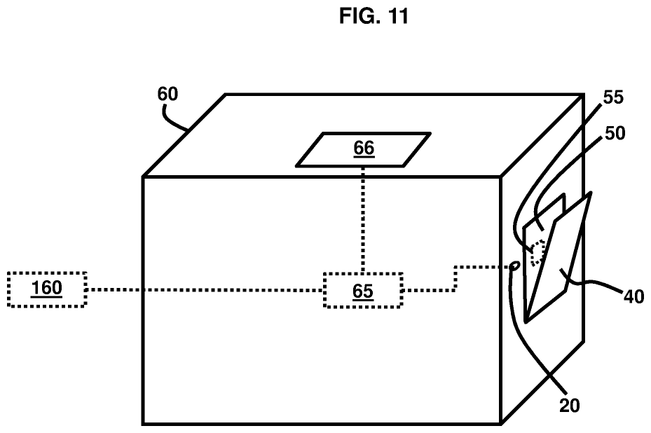

FIG. 11, with reference to FIGS. 1 through 10, illustrates a schematic diagram of the electronic device 60, according to an example. The positioning shown for the button 20, door 40, consumable compartment 50, processor 65, and display panel 66 are examples. As such, these components, as well as other features of the door lock 10 and door lock system 210 may be positioned at any suitable location on or in the electronic device 60. As shown in FIG. 11, the door 40 is shown as rotatable. However, as described above, the door 40 may be configured as any suitable type of access door and in any orientation and configuration. Moreover, while the consumable compartment 50 is shown in FIG. 11 as well as in the other drawings as being directly adjacent to the door 40, in other examples there may be intervening sections, doors, compartments, or other mechanisms between the door 40 and the consumable compartment 50. Additionally, the connections between the processor 65 and each of the button 20 and display panel 66 may be either direct connections or may be indirect with intervening components. The display panel 66 may provide the status of the state of operations of the door lock 10 and/or door lock system 210 including the state of engagement of the button 20 and door 40 as well as the status of the consumables 55 in the consumable compartment 50. In an example the consumables 55 may have a separate door, not shown, adjacent thereto for access to the consumables 55. The display panel 66 may indicate the multiple positions P₁, P₂, P₃ associated with the button 20 as well as indicate whether the door lock 10 and/or door lock system 210 is in a “ready” state or a “not ready” state. Furthermore, the output from the display panel 66 may be any of an audio and visual output, according to some examples. In another example, the processor 65 may communicatively control the button 20 to be engaged or pressed without user intervention or without being pressed by any type of engagement device. The instructions to the processor 65 to control the button 20 may occur by user input through the display panel 66 or may occur remotely through a remotely-located device 160, which may be a communication and/or computing device running a software application that is communicatively networked to the electronic device 60 either through a wireless or wired network connection.

Various examples described herein may include both hardware and software elements. The examples that are implemented in software may include firmware, resident software, microcode, etc. Other examples may include a computer program product configured to include a pre-configured set of instructions, which when performed, may result in actions as stated in conjunction with the methods described above. In an example, the preconfigured set of instructions may be stored on a tangible non-transitory computer readable medium or a program storage device containing software code.

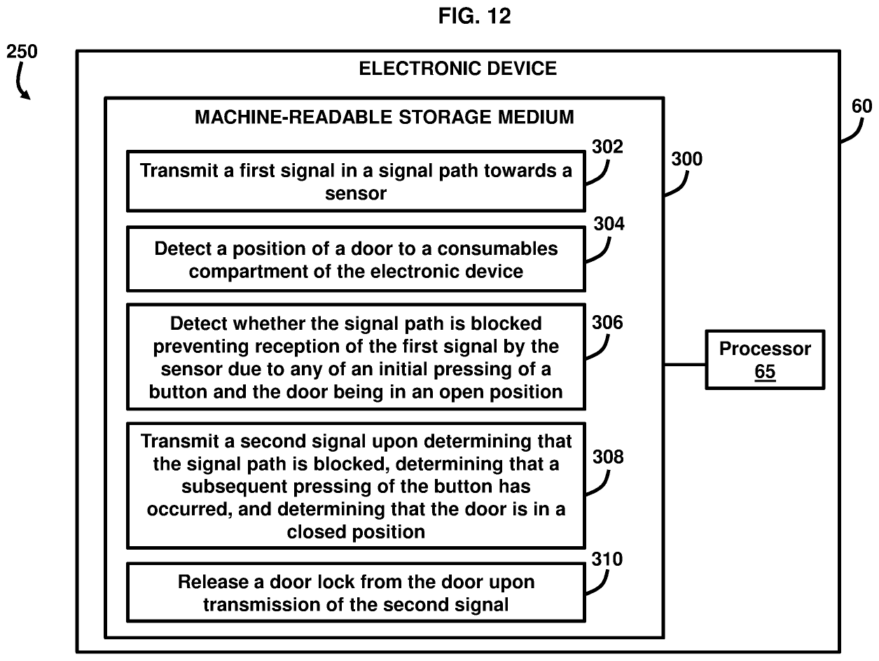

FIG. 12, with reference to FIGS. 1 through 11, illustrates a system 250 to control opening and closing a door 40 of an electronic device 60. In the example of FIG. 12, the electronic device 60 includes the processor 65 and a machine-readable storage medium 300. Processor 65 may include a central processing unit, microprocessors, hardware engines, and/or other hardware devices suitable for retrieval and execution of instructions stored in a machine-readable storage medium 300. Processor 65 may fetch, decode, and execute computer-executable instructions 302, 304, 306, 308, and 310 to enable execution of locally-hosted or remotely-hosted applications for controlling action of the electronic device 60. The remotely-hosted applications may be accessible on one or more remotely-located devices; for example, device 160. As an alternative or in addition to retrieving and executing instructions, processor 65 may include one or more electronic circuits including a number of electronic components for performing the functionality of one or more of the instructions 302, 304, 306, 308, and 310.

The machine-readable storage medium 300 may be any electronic, magnetic, optical, or other physical storage device that stores executable instructions. Thus, the machine-readable storage medium 300 may be, for example, Random Access Memory, an Electrically-Erasable Programmable Read-Only Memory, volatile memory, non-volatile memory, flash memory, a storage drive (e.g., a hard drive), a solid-state drive, optical drive, any type of storage disc (e.g., a compact disc, a DVD, etc.), and the like, or a combination thereof. In one example, the machine-readable storage medium 300 may include a non-transitory computer-readable storage medium. The machine-readable storage medium 300 may be encoded with executable instructions for enabling execution of remotely-hosted applications accessed on the one or more remotely-located devices 160.

In an example, the processor 65 of the electronic device 60 executes the computer-executable instructions 302, 304, 306, 308, and 310. For example, computer-executable transmitting instructions 302 may transmit a first signal 80 in a signal path 15 towards a sensor 70. Computer-executable detecting instructions 304 may detect a position of a door 40 to a consumables compartment 50 of the electronic device 60. Computer-executable detecting instructions 306 may detect whether the signal path 15 is blocked preventing reception of the first signal 80 by the sensor 70 due to any of an initial pressing of a button 20 and the door 40 being in an open position Pₒₚₑₙ. Computer-executable transmitting instructions 308 may transmit a second signal 85 upon determining that the signal path 15 is blocked, determining that a subsequent pressing of the button 20 has occurred, and determining that the door 40 is in a closed position P_{close}. Computer-executable releasing instructions 310 may release a door lock 10 from the door 40 upon transmission of the second signal 85. The first signal 80 comprises light 81, and the sensor 70 comprises an optical sensor 71 aligned with the signal path 15.

In some examples, the instructions 302, 304, 306, 308, and 310 may be part of an installation package that, when installed, can be executed by the processor 65 to implement the instructions 302, 304, 306, 308, and 310. In such examples, the machine-readable storage medium 300 may be a portable medium, such as a CD, DVD, or flash drive, or a memory maintained by an image processing device from which the installation package can be downloaded and installed. In other examples, the instructions may be part of an application, applications, component, or components already installed on the electronic device 60 including on the processor 65. In such examples, the machine-readable storage medium 300 may include memory such as a hard drive, solid state drive, or the like. In other examples, the functionalities of any of the instructions 302, 304, 306, 308, and 310 may be implemented in the form of electronic circuitry.

The present disclosure has been shown and described with reference to the foregoing exemplary implementations. Although specific examples have been illustrated and described herein it is manifestly intended that the scope of the claimed subject matter be limited only by the following claims and equivalents thereof. It is to be understood, however, that other forms, details, and examples may be made without departing from the spirit and scope of the disclosure that is defined in the following claims.

What is claimed is:

1. A door lock comprising:
a button comprising a first region and a second region, the button to actuate among multiple positions upon being engaged;
a first link member aligned to the button to detect a state of engagement of a door to a consumables compartment of an electronic device;
a sensor aligned to the button and the first link member to receive a signal from a signal generator based on the state of engagement of the door;
a second link member comprising a first end to align with the button, and a second end to engage the door; and
a transducer to cause the first end to align with the button to disengage the second end from the door upon engagement of the button with the first end.

2. The door lock of claim 1, wherein the first region of the button comprises a solid body, and the second region of the button comprises a hole.

3. The door lock of claim 2, wherein the multiple positions of the button comprise a first position, a second position, and a third position.

4. The door lock of claim 3, wherein the hole of the second region of the button is to permit transmission of the signal to the sensor upon the button being in the first position.

5. The door lock of claim 2, wherein the first region of the button is to block transmission of the signal to the sensor upon the button being actuated into the second position.

6. The door lock of claim 2, comprising:
a slot in the second link member; and
a pin slidably positioned in the slot to permit the second link member to actuate upon the button being actuated into the third position.

7. The door lock of claim 2, wherein the first link member is to block transmission of the signal to the sensor upon detecting that the door is in an open position.

8. A door lock system comprising:
a signal generator to transmit a first signal in a signal path;
a sensor to receive the first signal;
a button to open or block the signal path;
a first link member to detect a state of position of a door to a consumables compartment of an electronic device;
a processor operatively connected to the sensor and the first link member, the processor to:
detect whether the button is in a depressed position based on whether the sensor uninterruptedly receives the first signal;
receive the state of position of the door from the first link member; and
generate a second signal upon detecting that the sensor fails to receive the first signal, and determining that the state of position of the door is closed;
a second link member engaged by the button to unlock the door upon aligning with the button; and
a transducer to move the second link member in an aligned position with the button upon receiving the second signal from the processor.

9. The door lock system of claim 8, wherein the signal generator comprises a light emitting diode.

10. The door lock system of claim 8, wherein the second link member comprises a latch to retain the door in a locked position.

11. The door lock system of claim 8, comprising a plurality of springs biased against the button, the second link member, and the door.

12. The door lock system of claim 8, comprising a display panel operatively connected to the processor to output any of a status of the state of position of the door, a status of a position of the button, and an indication of whether the door is permitted to be in an open position.

13. The door lock system of claim 8, wherein the processor is to determine whether the door is to be opened once the button is depressed.

14. A machine-readable storage medium comprising instructions that when executed cause a processor of an electronic device to:
transmit a first signal in a signal path towards a sensor;
detect a position of a door to a consumables compartment of the electronic device;
detect whether the signal path is blocked preventing reception of the first signal by the sensor due to any of an initial pressing of a button and the door being in an open position;
transmit a second signal upon determining that the signal path is blocked, determining that a subsequent pressing of the button has occurred, and determining that the door is in a closed position; and
release a door lock from the door upon transmission of the second signal.

15. The machine-readable storage medium of claim 14, wherein the first signal comprises light, and wherein the sensor comprises an optical sensor aligned with the signal path.
